(19) United States
(12) Patent Application Publication
(10) Pub. No.: US 2014/0203163 A1
(43) Pub. Date: Jul. 24, 2014

(54) MOUNTING DEVICE FOR MOUNTING MOTOR INSTALLATION PLATE IN VENDING MACHINE

(71) Applicant: HON HAI PRECISION INDUSTRY CO., LTD., New Taipei (TW)

(72) Inventors: Yun-Lung CHEN, New Taipei (TW); Chin-Wen YEH, New Taipei (TW)

(73) Assignee: HON HAI PRECISION INDUSTRY CO., LTD., New Taipei (TW)

(21) Appl. No.: 14/022,490

(22) Filed: Sep. 10, 2013

(30) Foreign Application Priority Data
Jan. 24, 2013 (CN) 2013100266778

(51) Int. Cl. F16M 13/02

(52) U.S. Cl. CPC F16M 13/02
USPC 248/674

(57) ABSTRACT

A mounting device includes an installation plate for securing a motor, a chassis, a bracket, and a locking member. The chassis includes a locking piece. The bracket is secured to the chassis. The bracket holds the installation plate. The locking member is locked into the installation plate and the locking piece, to secure the installation plate to the chassis without setting rivets in the installation plate.

### BACKGROUND

1. Technical Field

The present disclosure relates to a vending machine, and particularly to a mounting device for an installation plate for mounting a motor in the vending machine.

2. Description of Related Art

In many vending machines, the dispensing assembly includes rigid coils and motors. The motor rotates the coil causing products to be pushed along a channel to eventually drop into a bin accessible by a customer. The motor is secured to a tray of the vending machines by a installation plate. Generally, the installation plate is secured to a flange of the tray, which needs a number of rivets, and the installation plate is secured to flange by a number of screws into the rivets. However, the securing process of the installation plate is time-consuming, and a structure of the flange is complicated and costly. Therefore, there is room for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of one embodiment of a mounting device and an installation plate.

FIG. 2 is an assembled, isometric view of the mounting device and the installation plate of FIG. 1.

FIG. 3 is a cross-sectional view taken along a line III-III of the mounting device and the installation plate of FIG. 2.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

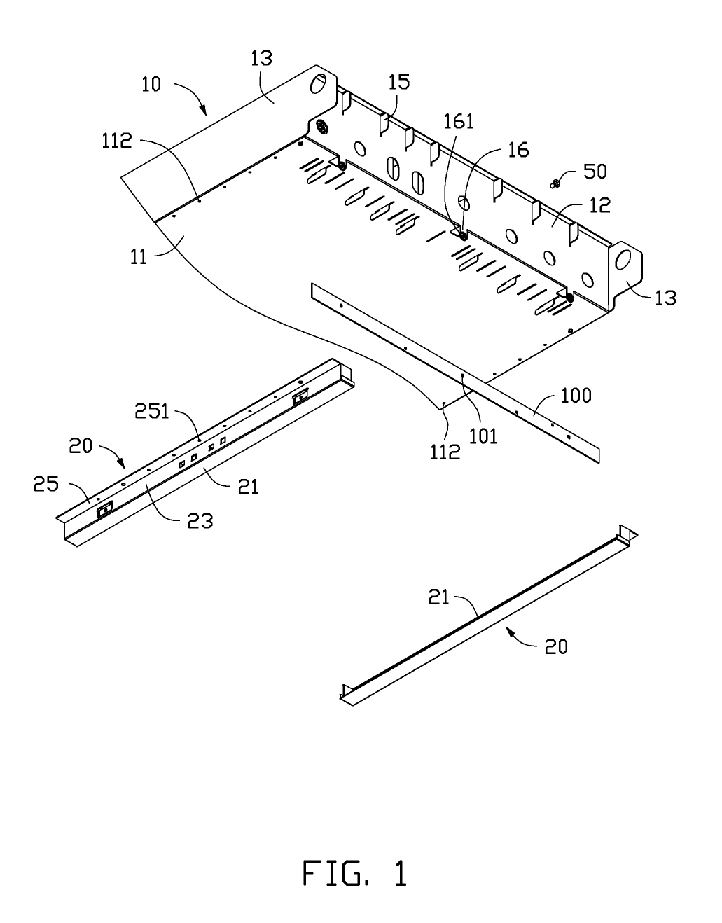

FIG. 1 shows one embodiment of a mounting device for securing an installation plate 100. The installation plate 100 is used for securing a plurality of motors (not shown) and defines a plurality of installation holes 101. The mounting device includes a chassis 10 and two brackets 20. In one embodiment, the chassis 10 is a product tray for placing product in a vending machine.

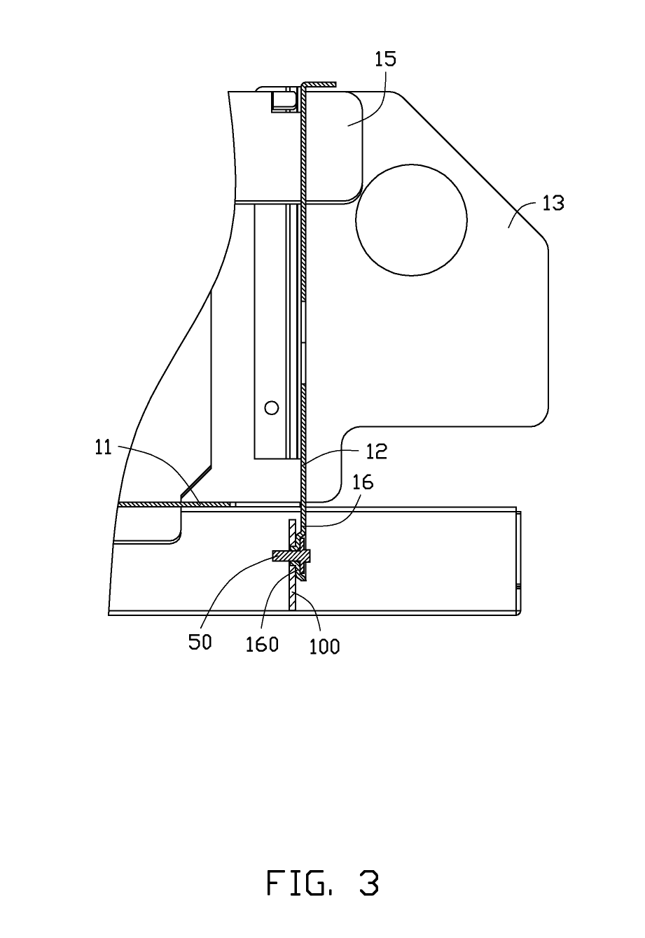

The chassis 10 includes a bottom plate 11, a front plate 12, and two side plates 13. The two side plates 13 are opposite to each other. In this embodiment, the bottom plate 11 is substantially perpendicular to the front plate 12 and the side plates 13, and the front plate 12 is substantially perpendicular to the side plates 13. The bottom plate 11 defines a plurality of mounting holes 112 adjacent to each side plate 13. A plurality of locking pieces 16 extends downwards from a bottom edge of the front plate 12. Each locking piece 16 is coplanar with the front plate 12. Each locking piece 16 defines a recess portion 160 (shown in FIG. 3). The recess portion 160 defines a locking hole 161 corresponding to one of the plurality of installation holes 101. A plurality of dividing plates 15 extends from the front plate 12. Each dividing plate 15 is substantially perpendicular to the front plate 12. A channel is defined between each two adjacent dividing plates 15 for receiving product (not shown).

Each bracket 20 includes a holding plate 21, a mounting plate 23, and a locking plate 25. The holding plate 21 and the locking plate 25 extend from opposite edges of the mounting plate 23 along two opposite directions. In this embodiment, the holding plate 21 is substantially perpendicular to the mounting plate 23 and substantially parallel to the locking plate 25, and the mounting plate 23 is substantially perpendicular to the locking plate 25. The bracket 20 is used for holding the chassis 10. The holding plate 21 is used for holding the installation plate 100. The mounting plate 23 is used for securing wheels (not shown), which slide the chassis 10. The locking plate 25 defines a plurality of positioning holes 251 corresponding to the plurality of mounting holes 112.

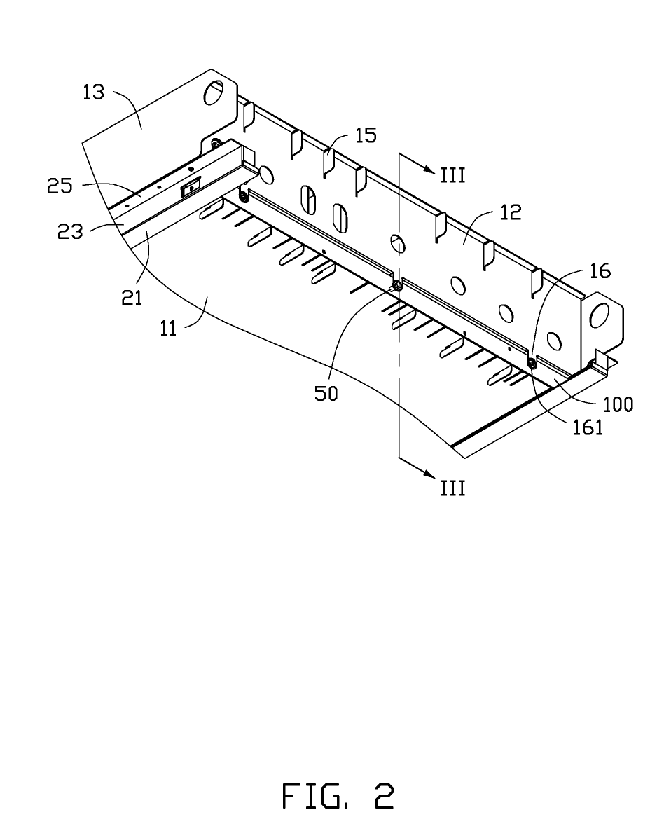

FIGS. 2 and 3 show that in assembly, the two brackets 20 are moved under two opposite ends of the bottom plate 11. The locking plate 25 abuts the bottom plate 11, and the positioning hole 251 is aligned with the mounting hole 112. Each bracket 20 is secured to the bottom plate 11 by a plurality of screws inserted through the positioning holes 251 and the mounting holes 112. The installation plate 100 is placed on the two brackets 20, and the recess portion 160 abuts the installation plate 100. The locking hole 161 is aligned with the installation hole 101. A locking member 50 is inserted through the locking hole 161 and the installation hole 101, to secure the installation plate 100 to the locking piece 16. The holding plate 21 is substantially parallel to the bottom plate 11. In other embodiments, the installation plate 100 is latched to the locking piece 16.

In disassembly, the locking member 50 is removed from the locking piece 16 and the installation plate 100, and then the installation plate 100 can be removed from the bracket 20 and the chassis 10.

It is to be understood, however, that even though numerous characteristics and advantages have been set forth in the foregoing description of embodiments, together with details of the structures and functions of the embodiments, the disclosure is illustrative only and changes may be made in detail, especially in the matters of shape, size, and the arrangement of parts within the principles of the disclosure, to the full extent indicated by the broad general meaning of the terms in which the appended claims are expressed.

What is claimed is:

1. A mounting device, comprising:
an installation plate for securing a motor;
a chassis comprising a bottom plate; a front plate, which is substantially perpendicular to the bottom plate; and a locking piece extending from the front plate;
a bracket secured to the bottom plate; and
a locking member;
wherein the bracket holds the installation plate; and the locking member is locked into the installation plate and the locking piece, to secure the installation plate to the front plate.

2. The mounting device of claim 1, wherein the locking piece is coplanar with the front plate.

3. The mounting device of claim 1, wherein the installation plate is substantially parallel to the front plate.

4. The mounting device of claim 1, wherein the locking piece defines a recess portion with a locking hole, the installation plate defines an installation hole, and the locking member is locked into the installation hole and the locking hole.

5. The mounting device of claim 4, wherein the recess portion abuts the installation plate, and the locking piece is substantially parallel to the installation plate.

6. The mounting device of claim 1, wherein the bracket comprises a holding plate, a mounting plate, and a locking plate, and the holding plate and the locking plate extend from opposite edges of the mounting plate along two opposite directions.

7. The mounting device of claim 6, wherein the bracket is under the bottom plate, and the locking plate is secured to the bottom plate.

8. The mounting device of claim 6, wherein the mounting plate is substantially perpendicular to the holding plate and the locking plate.

9. The mounting device of claim 6, wherein the bracket is configured for holding the chassis, the mounting plate is configured for securing wheels, and the mounting plate is substantially perpendicular to the bottom plate.

10. The mounting device of claim 1, wherein the chassis is a tray of a vending machine for placing products.

11. A mounting device, comprising:
an installation plate for securing a motor;
a chassis comprising a bottom plate; a front plate, which is substantially perpendicular to the bottom plate; and a locking piece extending from the front plate;
a bracket secured to the bottom plate; and
a locking member;
wherein the locking piece and the front plate are integral, and the locking piece is coplanar with the front plate; the bracket holds the installation plate; and the locking member is locked into the installation plate and the locking piece, to secure the installation plate to the front plate.

12. The mounting device of claim 11, wherein the installation plate is substantially parallel to the front plate.

13. The mounting device of claim 11, wherein the locking piece defines a recess portion with a locking hole, the installation plate defines an installation hole, and the locking member is locked into the installation hole and the locking hole.

14. The mounting device of claim 13, wherein the recess portion abuts the installation plate, and the locking piece is substantially parallel to the installation plate.

15. The mounting device of claim 11, wherein the bracket comprises a holding plate, a mounting plate, and a locking plate, and the holding plate and the locking plate extend from opposite edges of the mounting plate along two opposite directions.

16. The mounting device of claim 15, wherein the bracket is under the bottom plate, and the locking plate is secured to the bottom plate.

17. The mounting device of claim 15, wherein the mounting plate is substantially perpendicular to the holding plate and the locking plate.

18. The mounting device of claim 15, wherein the bracket is configured for holding the chassis, the mounting plate is configured for securing wheels, and the mounting plate is substantially perpendicular to the bottom plate.

19. The mounting device of claim 11, wherein the chassis is a tray of a vending machine for placing products.
